(19) United States
(12) Patent Application Publication
(10) Pub. No.: US 2023/0206160 A1
(43) Pub. Date: Jun. 29, 2023

(54) SYSTEMS AND METHODS FOR RAPPORT DETERMINATION

(71) Applicant: Calabrio, Inc., Minneapolis, MN (US)

(72) Inventors: Laura Cattaneo, Rochester, MN (US); Boris Chaplin, Medina, MN (US); Kyle Smaagard, Forest Lake, MN (US); Chris Vanciu, Isle, MN (US); Dylan Morgan, Minneapolis, MN (US); Matt Matsui, Minneapolis, MN (US); Paul Gordon, Minneapolis, MN (US); Catherine Bullock, Minneapolis, MN (US)

(21) Appl. No.: 18/046,469

(22) Filed: Oct. 13, 2022

Related U.S. Application Data
(60) Provisional application No. 63/294,678, filed on Dec. 29, 2021.

(51) Int. Cl. G06Q 10/06; H04M 3/51

(52) U.S. Cl. CPC G06Q 10/06398; H04M 3/5175; H04M 2203/401; H04M 2203/551; H04M 2203/558

(57) ABSTRACT

Systems and methods are provided for determining a rapport score for a contact. Data associated with a contact may include an audio recording, a transcript, metadata, and/or other contact data collected during or generated after a contact. One or more rapport models are applied to the contact data to generate rapport metrics that capture one aspect of the rapport during a contact. Rapport metrics can be compared to target rapport metrics to determine whether the rapport metric indicates positive rapport during the contact. From rapport metrics, a rapport score can be generated that indicates the overall rapport for the contact. Rapport metrics, rapport scores, and other information associated with a contact can be provided in a manner that allows for useful evaluation of whether contact participants developed positive rapport during a contact and/or a series of contacts over time.

### CROSS-REFERENCE TO RELATED APPLICATIONS

This application claims priority to U.S. Provisional Application No. 63/294,678, filed Dec. 29, 2021, titled “Systems and Methods for Rapport Determination,” the entire disclosures of which is hereby incorporated herein by reference.

### BACKGROUND

When humans interact, some interactions are more positive or productive than others. People may walk away from an interaction with a positive or negative feeling about the interaction depending on, among other things, the rapport that they experienced with others during the interaction. In a customer service business, it is important to encourage and incentivize customer-facing employees to develop positive rapport with customers. For a manager, supervisor, or other similar individual overseeing customer interactions, it may be desirable to track the rapport between customers and the individuals interacting with those customers or with any other business partners. Because rapport depends on a number of factors during any given interaction, it may be desirable to track individual aspects of rapport during an interaction to assess an overall level of rapport for the interaction. While customer feedback may provide subjective assessments of rapport during interactions, this subjective feedback may not clearly identify specific aspects of an interaction that contributed positively or negatively to the rapport during the interaction.

In particular, professional call centers may wish to track rapport between agents (e.g., call operators) and customers over a number of interactions. The call center may wish to assess an agent's performance with respect to generating and maintaining positive rapport with customers and may further wish to identify ways in which an agent positively or negatively contributed to the rapport of each interaction. There is a need to track rapport and aspects of rapport across a number of interactions for agent and customers in a manner that allows for evaluation of agent performance. Thus, a technology that determines rapport for interactions based on data from those interactions is needed.

It is with respect to these and other general considerations that the aspects disclosed herein have been made. Although relatively specific problems may be discussed, it should be understood that the examples should not be limited to solving the specific problems identified in the background or elsewhere in this disclosure.

### SUMMARY

Aspects of the present disclosure relate to determining rapport metrics and a rapport score for a contact based on contact data associated with the contact. As used herein, a contact may be a communication (e.g., a call, a phone call, an email, an instant message, and the like) among participants, such as any combination of agents, customers, and/or supervisors. Accordingly, the contact may include one or more conversations between participants including speakers. For example, a contact may take place between a customer and a call center agent receiving a phone call. The contact data may include recordings of a contact and/or a transcription of the contact.

A rapport engine receives contact data and, from the contact data, determines one or more rapport metrics relating to an aspect of the rapport during the contact. Using the rapport metrics, the rapport engine determines a rapport score for the contact. The rapport score may be based on comparison of the rapport metrics to target rapport metrics that are believed to represent an optimal or ideal measure for a rapport metric. Rapport scores for contacts may be stored over time, allowing for readily accessible data regarding rapport metrics and rapport scores for contact participants.

This Summary introduces a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an exemplary system 100 for determining a rapport score from rapport metrics based on contact data.

FIG. 2 illustrates an exemplary system 200 for determining a rapport score based on contact data in accordance with aspects of the present disclosure.

FIG. 3 illustrates an exemplary method 300 for determining and providing a rapport score based on contact data.

FIG. 4 illustrates an exemplary method 400 for determining a normalized rapport metric.

FIG. 5 illustrates an exemplary method 500 for providing a rapport score for a selected portion of contact data.

FIG. 6 illustrates an exemplary method for determining a rapport score and providing a notification during an ongoing call.

FIG. 7 illustrates an exemplary method for determining and storing a rapport score and rapport score data.

FIGS. 8A and 8B illustrate exemplary historical rapport data.

FIG. 9 illustrates an exemplary method for calibrating rapport score parameters based on customer feedback data.

FIG. 10 illustrates a simplified block diagram of a device with which aspects of the present disclosure may be practiced in accordance with aspects of the present disclosure.

### DETAILED DESCRIPTION

Various aspects of the disclosure are described more fully below with reference to the accompanying drawings, which from a part hereof, and which show specific example aspects. However, different aspects of the disclosure may be implemented in many different ways and should not be construed as limited to the aspects set forth herein; rather, these aspects are provided so that this disclosure will be thorough and complete and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

As discussed in more detail below, the present disclosure relates to determining a rapport score from the content of contacts. In aspects, a rapport engine receives contact data. The contact data may include audio data associated with a contact and, in some instances, a transcription of the audio data. In aspects, the rapport engine may generate a transcript associated with the contact data. The rapport engine applies one or more rapport metric models to determine one or more rapport metrics from the contact data. The rapport models may relate to different aspects of the contact associated with the rapport between an agent and a customer during the contact. The rapport engine may normalize the rapport metric based on, for example, the extent to which the rapport metric deviates from a predetermined target rapport metric associated with the determined rapport metric. In aspects, the target rapport metric indicates an ideal performance for a given rapport metric, such that the closeness of the rapport metric to the target rapport metric indicates a high degree of rapport during a contact. Based on the one or more normalized rapport metrics, the rapport engine determines a rapport score, which may represent the overall level of rapport during the contact and which may be derived from a single rapport metric or a combination of multiple rapport metrics determined from the contact data.

Aspects of the present disclosure provide, among other benefits, improvements over prior solutions by tracking rapport for a contact in different levels of granularity and in real-time. In doing so, feedback may be provided to a user in real-time which allows the user to adjust the direction of the contact improve rapport with the other party. Further, aspects of the present disclosure utilize machine learning models to determine rapport between two parties in a way that is not heavily influenced by subjective interpretations by either party or by the ultimate outcome of the contact, which may not be indicative of the actual rapport between the parties to the contact. As such, via use of machine learning and other technological features disclosed herein, aspects of the present disclosure provide a technical improvement over existing solutions, which rely upon subjective self-evaluations or monitoring by third-parties, which are not able to provide non-subjective feedback, granular evaluations, or real-time feedback during the course of the contact.

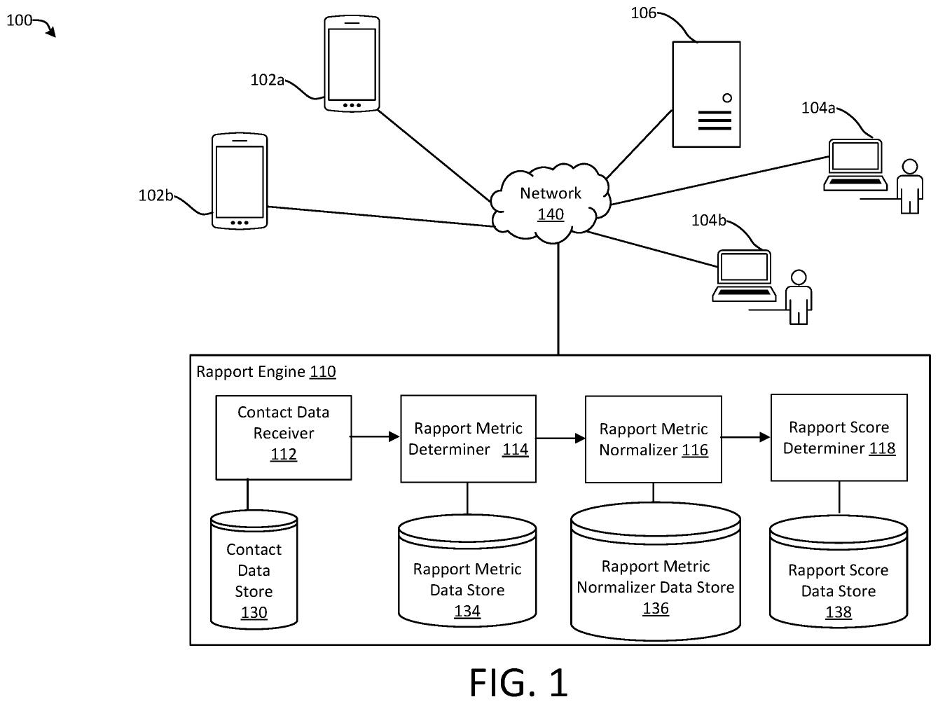

FIG. 1 illustrates an overview of an exemplary system 100 for determining a rapport score from rapport metrics based on contact data. The system 100 may include a client-computing device 102, a computer terminal 104, a virtual assistant server 106, and a rapport engine 110 connected via a network 140. In aspects, the client-computing device 102 may include a smartphone and/or a phone device where a user may participate in a contact or join a conversation with another speaker. The computer terminal 104 may include an operator station where an operator of a contact center may receive incoming contacts from customers (e.g., a user using the client-computing device 102). In alternate aspects, the virtual assistant server 106 may process a virtual assistant for the user using the client-computing device 102 over the network 140. In said scenarios, the user using the client-computing device 102 may join a conversation with a virtual assistant. The network 140 may be a computer communication network. Additionally, or alternatively, the network 140 may include a public or private telecommunication network exchange to interconnect with ordinary phones (e.g., the phone devices).

The contact data receiver 112 receives contact data associated with a contact between client-computer device 102 and computer terminal 104. As used herein, a contact may be a communication (e.g., a call, a phone call, an email, a video call, an instant message, and the like) among participants. Accordingly, the contact may include one or more conversations between participants including speakers. For example, a contact may take place between a customer and a call center agent receiving a phone call. In aspects, the term “contact data” may include content and attributes associated with a contact. For example, the contact data may include a recording of content of a contact (e.g., audio data), a transcript in text form of content of the contact (e.g., transcript data), audio characteristics of content of the contact, attributes of the contact (e.g., tone, pitch, and the like), text of the contact (e.g., an email or instant message conversation), and any other data or metadata as will be appreciated by one of skill in the art. The attributes of the contact may include, for example, one or more speaker identifiers identifying the particular call, the department or organization receiving the contact, etc., an identifier of a contact center operator who received the call, and a contact duration.

Rapport metric determiner 114 determines a rapport metric from contact data received, e.g., from network 140. In aspects, a rapport metric is a numerical value representing a measure of rapport between participants in a contact. Rapport metric determiner 114 may determine a single rapport metric or a plurality of different rapport metrics from the contact data for a given contact, with each rapport metric measuring an aspect of the rapport between the participants for the contact. Rapport metric determiner 114 may determine a rapport metric based on application of one or more rapport models to the contact data. A rapport model may be one or more sets of rules or relationships describing how a rapport metric may be determined based on contact data. While the present disclosure is not limited to any specific rapport metrics or models, certain example rapport metrics are provided herein to illustrate the types and variety of rapport metrics that may be used by rapport metric determiner 114.

In one non-limiting example, a rapport metric relates to relative speaking time of participants during a contact. Such a rapport metric may measure the relative time spent by each participant in a contact contributing to the contact, such as by speaking, typing, or the like. In this example, the rapport metric may be a number, such as a percentage or decimal, indicating a participant's relative contribution to the contact. For example, the rapport metric may be a number between 0 and 1 (though other ranges or classifications can be used) indicating an amount of time during which a participant was speaking during a contact, divided by the total length of the contact. Additionally, or alternatively, the rapport metric may indicate a number of words spoken or typed by a participant during a contact, divided by the total number of words spoken or typed by all participants during a contact.

In another non-limiting example, the rapport metric may relate to a number or rate of interruptions during a contact. In this example, the rapport metric may be a number of interruptions detected in the contact data. The number of interruptions may be based on an analysis of audio data, transcription data, or any other contact data. The rapport metric may also indicate a rate of interruptions during a contact, such as by dividing the number of interruptions by a length of the contact or number of utterances during the contact. In this way, the rapport metric may reflect the expectation that a longer contact or a contact with a higher volume of total content exchanged between participants may have a higher number of total detected interruptions compared to a shorter contact or a contact with a lower volume of total content.

In another non-limiting example, the rapport metric may relate to the speed of an agent's, a customer's, or any other participant's speech during a contact. In aspects, the speech speed metric may indicate an average speech speed by all participants during a contact or only the speech speed of an agent. In other aspects, the speech speed metric may indicate a relative speech speed of one participant (e.g., an agent) compared to another participant (e.g., a customer) such that the metric indicates whether one participant is speaking faster or slower than the other participant during a contact.

In another non-limiting example, the rapport metric may relate to the frequency at which a contact participant uses the name of another contact participant. In aspects, such a name-use frequency metric may represent a total number of name uses detected in the contact data based on an analysis of audio data, transcription data, or any other contact data. Additionally, or alternatively, the metric may indicate a rate of name use during a contact, such as by dividing the number of detected name uses by a total length of the contact, number of utterances during the contact, or the like.

In another non-limiting example, the rapport metric may relate to an emotional model that is operable to analyze the contact data using techniques to determine or approximate the emotional state(s) of participants during a contact. The emotional model may determine the emotional states of participants during a contact based on contact data. As one example, the emotional model may determine the emotional state(s) of contact participants by determining a level of positive emotion (e.g., happiness) for utterances within a contact and comparing the level of positive emotion across multiple utterances during the contact (e.g., by comparing the level of positive emotion for one participant during an utterance to the level of positive emotion for another participant during a responsive or subsequent utterance). In aspects, an emotional model may be trained or otherwise customized to determine emotional states for specific customers or for specific industries or topics of conversation during a contact. In other aspects, the emotional model may be generic, such that the model is customer- and industry-independent. Additionally, or alternatively, the emotional model may be any model (e.g., an off-the-shelf model appreciated by one of skill in the art) capable of identifying emotional states using audio or other contact data.

In another non-limiting example, the rapport metric may relate to how well one participant (e.g., an agent) is mirroring another participant (e.g., a customer). In aspects, contact data used to evaluate mirroring during a contact may include voice tone data, other related audio data, or transcript data of a contact. For example, voice tone data may be used to determine the similarity between audio features in the data for different contact participants, which would indicate that the agent is mirroring the tone of the customer. In other examples, voice tone data, transcript data, or a combination of multiple types of contact data may be used to determine a Euclidean distance between contact features. In still other examples, contact data may be used to determine the cosine similarity between vectorized pairs of statements/responses by the participants during the contact, which would indicate how well one contact participant (e.g., an agent) is mirroring another participant (e.g., a customer). It will be appreciated that there are many techniques that may be employed to approximate mirroring during a contact, and other techniques and methods may be used. For example, using transcript data, it will be appreciated that mirroring could be determined by determining Levenshtein distance between participants' statements/responses during the contact or use of a bag-of-words technique to identify important words during a contact and compare the use of identified important words by one participant and another participant.

In another non-limiting example, the rapport metric may relate to a relationship model that is operable to analyze the contact data using techniques to determine or approximate the amount of relationship building accomplished during a contact. Determining such a rapport metric may involve, for example, using topic modeling to measure the extent to which a participant (e.g., an agent) attempts to understand the needs expressed by another participant (e.g., a customer). In aspects, the extent to which a participant attempts to understand the needs of another participant may be measured by the amount of time the participant spends on attempting to understand those needs. Determining an amount or extent of understanding may involve using topic modeling, such as Latent Dirichlet Allocation (LDA) or other similar technique, to determine topics raised during a contact and select topics that are most closely related to strong rapport. Determining the relationship-building metric may then be accomplished by evaluating contact data and determining the amount of each contact relating to the identified topic(s).

In another non-limiting example, the rapport metric may relate to a measure of how well one participant (e.g., an agent) has resolved questions posed by another participant (e.g., a customer). Such a metric may count both the number of questions asked by one participant and the number of questions answered by the other participant. The metric may be a count of unresolved questions. Additionally, or alternatively, the metric may represent the percentage or fraction of questions that have been closed. In aspects, a count of asked/answered questions may be determined by using a phrase list to identify key words in the questions and then determining whether an answer is provided to those questions using the same, similar, or related key words in an answer. In other aspects, a count or measure of asked/answered questions may be determined by training and/or using a machine-learning classifier operable to identify questions posed by a participant and further operable to identify an answer or response associated with the question, such that the classifier is able to label questions as either open or closed. It will be appreciated that these example techniques for measuring asked/answered questions are provided as illustrative examples and that a number of additional or alternative techniques may be employed to achieve the same or a similar metric.

In another non-limiting example, the rapport metric may relate to a measure of the type of questions asked and/or answered by participants. For example, such a metric may identify questions from the contact data and classify each identified question according to different categories of questions. In aspects, questions may be classified as being either “open” questions or “closed” questions, where open questions are questions that do not readily lend themselves to a “yes” or “no” answer and closed questions are those that do. A metric relating to a measurement of open/closed questions may represent a ratio of one type of question to another (e.g., a ratio of open questions to closed questions). In other aspects, the metric may represent a total count of each type of question. As with a metric relating to asked/answered questions discussed above, determination of open/closed questions may be possible by training and/or using a machine-learning classifier that is able to identify and classify questions based on, among other things, key words or contextual indicators that may be associated with different categories of questions.

It will be appreciated that for a given set of received contact data, rapport metric determiner 114 may determine a single rapport metric or a plurality of different rapport metrics. The decision regarding which rapport metrics to determine may depend on, for example, the type of contact data received by or accessible to rapport metric determiner 114. For example, certain rapport metrics may only be available to rapport metric determiner 114 when the contact data includes audio data from the contact, while others may only be available when the contact data includes transcription data. Still others may only be available when the contact data contains certain metadata, such as voice tone or similar acoustic property data that may be used, e.g., by an emotional model to capture participant emotional states during a contact. It will be appreciated that rapport metric determiner 114 is able to determine which rapport metrics to determine the availability of certain rapport metrics based on the type and quality of contact data received.

Additionally, or alternatively, the decision of which rapport metrics to determine may depend on the stored preferences of the administrator responsible for implementing rapport engine 110. In aspects, the number and type of rapport metrics available for rapport metric determiner 114 may depend on an administrator's subscription tier, where the administrator may be enrolled in a subscription that allows the administrator to utilize certain rapport metrics but not others when operating the rapport metric determiner 114. It will further be appreciated that the rapport metrics available to the rapport metric determiner 114 may increase, decrease, or otherwise change over time. For instance, rapport metric determiner may gain access to additional rapport metrics over time as new rapport models are developed and deployed in rapport engine 110.

Rapport metric normalizer 116 may normalize the rapport metrics determined by rapport metric determiner 114. As discussed above, a rapport metric determined by the rapport metric determiner may be a numerical value. In certain instances, though, the numerical value lacks appropriate context from which rapport engine 110 can assess the meaning of the rapport metric with respect to the measure of rapport for a given contact. For instance, there may be some rapport metrics for which a higher numerical value indicates a higher level of rapport during a contact (e.g., a name-use rate), while there are other rapport metrics for which a higher numerical value indicates a lower level of rapport during a contact (e.g., an interruption rate). For other rapport metrics, a higher level of rapport during a contact may be associated with neither a higher or a lower rapport metric but, rather, with the rapport metric being close to a target, such as a rapport metric measuring the relative speaking time of contact participants, which may indicate a higher level of rapport if the relative speaking time for participants is more equal (e.g., closer to 50% for each participant in a contact having two participants). Thus, in at least some cases, it may be appropriate for rapport metric normalizer 116 to employ certain techniques to place the rapport metric in useful context by normalizing the rapport metric.

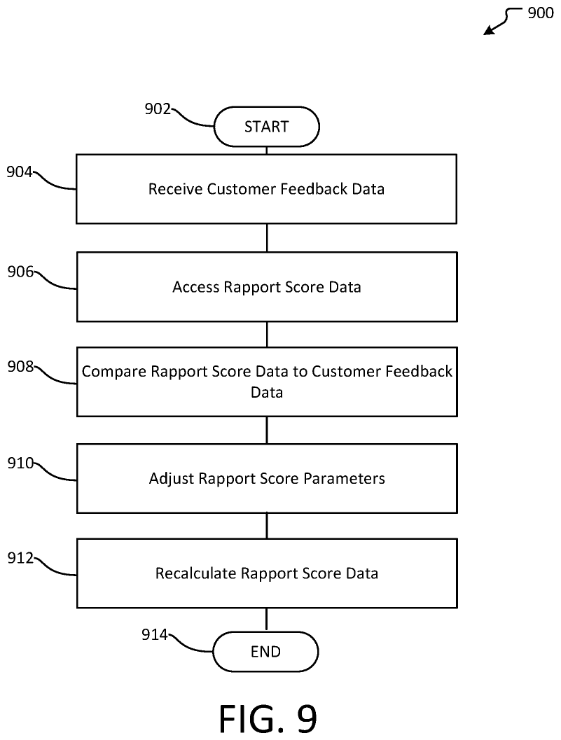

It will be appreciated that there are a number of techniques that may be implemented by rapport metric normalizer 116 to normalize the rapport metrics. In one non-limiting example, rapport metric normalizer 116 normalizes one or more rapport metrics by comparing the rapport metrics to target rapport metrics. In such an example, each of the one or more rapport metrics may be associated with a target rapport metric, which represents the optimal value for that particular rapport metric. It will be appreciated that the optimal value for one rapport metric may be the same as or may differ from the optimal value for another rapport metric, such that a first rapport metric and a second rapport metric may be associated with a first target rapport metric and a second rapport metric, respectively. The target rapport metrics for the respective rapport metrics may be predetermined and stored, e.g., in rapport metric normalizer data store 136. Additionally or alternatively, one or more target rapport metrics may be generated and dynamically adjusted by rapport metric normalizer 116, as will be discussed in greater detail in connection with FIG. 9, below.

As an illustrative example of a target rapport metric, consider one of the examples identified above: a rapport metric indicating a relative speaking time of participants. As an illustrative example, the rapport metric may indicate that a contact participant (e.g., an agent) contributed 60% of the total volume of content for a contact (e.g., 60% of the utterances, 60% of the total speaking time during the contact, or any other similar measurement of relative contribution). The rapport metric may, therefore, be a value of 0.60 for the contact. As part of normalizing this rapport metric, rapport metric normalizer 116 may access a target rapport metric for the relative speaking time metric. The target metric may indicate that the optimal relative speaking time for the agent is 50% contribution, or 0.50.

Once a target rapport metric is accessed and/or identified for a given rapport metric, rapport metric normalizer 116 may generate a normalized rapport metric by comparing the rapport metric to the target rapport metric. In aspects, comparing the rapport metric to the target rapport metric includes determining the extent to which the rapport metric deviates from the target rapport metric. The rapport metric deviation may, for instance, indicate a difference between the rapport metric and the target rapport metric. Or, in another example, the rapport metric deviation may indicate a percentage deviation from the target rapport metric. It will be appreciated that there are a number of techniques that may be used to compare a rapport metric to a target rapport metric, as well as to determine an amount of deviation of the rapport metric from the target rapport metric.

Continuing the illustrative example offered above regarding a relative speaking time metric, a rapport metric deviation could be 0.10—the difference between the 0.60 rapport metric and the 0.50 target rapport metric—or, alternatively, could be 20%, the percent difference between the 0.60 rapport metric and the 0.50 target rapport metric. It will be appreciated that there are several techniques that may be used to evaluate the extent to which a rapport metric deviates from a given target.

Rapport metric normalizer 116 may further determine a normalized rapport metric, which may be based on the rapport metric deviation described above. In aspects, the normalized rapport metric is a numerical value, such as a numerical value between 0 and 1 or between 0 and 100. The normalized rapport metric may indicate the extent to which the rapport metric deviates—or, conversely, does not deviate—from the target rapport metric. For example, a normalized rapport metric may be inversely correlated with the rapport metric deviation, such that a higher normalized rapport metric indicates a lower degree of deviation from the target rapport metric. That is, a rapport metric that is closer to its associated target rapport metric would lead to a higher normalized rapport metric, while a rapport metric that is further from its target would lead to a lower normalized rapport metric.

To determine the normalized rapport metric from the rapport metric deviation, the rapport metric normalizer 116 may apply a normalization function. As one non-limiting example, a normalization function may be provided by the following equation, in which NRM is a normalized rapport metric and RAID is a percentage rapport metric deviation:

NRM=100−RMD

In the non-limiting example in which the normalization function above is utilized, the normalized rapport metric decreases by one point for each additional percentage deviation of the rapport metric from the target rapport metric. It will be appreciated, though, that there are many other forms of normalization function that may be utilized. As another non-limiting example, a normalization function may be as follows:

$$NRM = 100 - {( \frac{RMD}{5} )}^{2}$$

In this second illustrative normalization function, the addition of the exponent to the RMD value introduces a harsher penalty for larger deviations from the target metric, while the division by 5 reduces the penalty for smaller deviations. More specifically, deviations less than 10% have little effect on the normalized rapport metric, but larger deviations above 10% quickly reduce the normalized rapport metric.

The normalization function may be the same for different rapport metrics or, alternatively, may be different for different rapport metrics. For instance, it may be determined that for a first rapport metric it is not uncommon or particularly concerning to see relatively large deviations from the target rapport metric. On the other hand, for a second rapport metric, it may be determined that even the smallest deviations from a second target rapport metric indicate a severe deterioration in rapport for a contact. Thus, the first and second rapport metrics may not only have different target rapport metrics, but they may also have different normalization functions that impose an appropriate penalty for deviations from the target.

In other aspects, a normalization function may involve the combination of one or more rapport metrics to produce a normalized rapport metric. For example, a rapport metric function may be configured to determine a normalized rapport metric by evaluating multiple rapport metrics and determining that the rapport metrics fall within certain ranges and/or fall below or above certain thresholds. In a non-limiting example, a normalization function may determine that if a first rapport metric falls within a specified range (e.g., an interruption rapport metric indicates fewer than five interruptions during a contact) and a second rapport metric falls within a specified range (e.g., an open/closed question metric indicates fewer than three open questions during the contact), the normalized rapport metric should be a value indicating this relationship between the first and second rapport metrics. In another non-limiting example, a normalization function may use the first and second rapport metrics as inputs to the function, such as a normalization function that divides or multiplies the first rapport metric by the second rapport metric to generate a normalized rapport metric.

It will be appreciated that there are many techniques for normalizing rapport metrics and applying a normalization function is only one example technique. For instance, another non-limiting example technique may involve comparison of rapport metrics to historical rapport data to determine how a rapport metric for a given contact compares to the same or similar rapport metric for past contacts. In such an example, rapport metric data store 134 and/or rapport metric normalizer data store 136 may store historical rapport data from contacts previously analyzed by rapport engine 110. The historical rapport data may be limited to contacts for a given agent or customer or may not be so limited and may contain data for any number of agents, customers, or past contacts.

Rapport metric normalizer 116 may access historical rapport data after comparing a rapport metric to its associated target rapport metric. When accessing the historical rapport data, rapport metric normalizer 116 may determine whether—and, if so, the extent to which—the same or similar rapport metric for past contacts has deviated from the target rapport metric. In aspects, rapport metric normalizer 116 compares the rapport metric deviation for the contact currently being evaluated by rapport engine 110 to the rapport metric deviation of the rapport metric in the historical rapport data and generates a normalized rapport metric based on that comparison. For example, the normalized rapport metric may represent a percentile performance, where a normalized rapport metric of 100 indicates that the rapport metric deviates less than the same or similar rapport metric in all prior contacts, while a normalized rapport metric of 50 indicates that the rapport metric deviation is approximately average.

Rapport score determiner 118 generates a rapport score for a contact based on the one or more rapport metrics associated with the contact. Rapport score determiner 118 may generate the rapport score based on rapport metrics determined by rapport metric determiner 114, rapport metrics that have been normalized by rapport metric normalizer 116, or both. In the event there is a single rapport metric associated with a contact, rapport score determiner 118 may determine a rapport score based on that rapport metric alone. In other aspects, rapport score determiner 118 may receive a plurality of rapport score metrics associated with a contact. In such an instance, rapport score determiner 118 may determine a rapport score for the contact by combining the rapport score metrics for the contact. In aspects, the rapport score determiner combines the rapport score metrics by determining a weighted combination of the metrics. For instance, the rapport score determiner may receive a first normalized rapport metric and second normalized rapport metric from rapport metric normalizer 116. In such an instance, rapport score determiner 118 may combine the first and the second normalized rapport metrics by, for example, averaging the normalized rapport metrics.

In some cases, it may be determined that certain rapport metrics are more important in determining a rapport score for a contact. As one example, it may be determined that a high frequency of interruptions during a contact is highly correlated with low rapport between participants in a contact, while the ratio of speaking/typing time has a weaker correlation with the rapport between contact participants. In such a non-limiting example, rapport score determiner 118 may, when determining the rapport score for the contact, give greater consideration to a first rapport metric measuring interruption frequency compared to a second rapport metric measuring relative speaking/typing time. One exemplary technique that rapport score determiner 118 may employ in such an instance is to determine a rapport score using a weighted average of the received rapport metrics. Rapport score determiner 118 may receive weighting values (or “weights”) associated with each of the received rapport metrics. The rapport score determiner may use these rapport score weights to generate a weighted combination (e.g., a weighted average) from the received rapport metrics, which can be used as a rapport score for the contact. In another exemplary technique, the rapport score determiner may determine a rapport score by determining a sum or a weighted sum of received rapport metrics. In yet another exemplary technique, the rapport score determiner may determine a rapport score by identifying a maximum or minimum value of the received rapport metrics. Moreover, rapport score determiner may sort received rapport metrics and categorize the received rapport metrics according to tiers (e.g., tiers representing relative performance for each of the rapport metrics) and use the tiers to determine a rapport score for the contact.

After determining a rapport score for a contact according to one or more of the techniques described herein, rapport score determiner 118 may further provide the rapport score. Providing the rapport score may include transmitting the rapport score over a network, such as network 140. Additionally, or alternatively, providing the rapport score may include storing the rapport score in a database, such as rapport score data store 138 or the like. In aspects, providing the rapport score may entail presenting the rapport score on a display, such as the display of computer terminal 104 or client-computer device 102.

When a rapport score is stored, transmitted, displayed or otherwise provided by rapport score determiner 118, it may be accompanied by rapport data associated with past contacts (or “historical rapport data”). The historical rapport data may include, for example, rapport metrics and rapport scores from prior contacts that have been processed by rapport engine 110. These past rapport scores and past rapport metrics may, for example, be stored in rapport score data score 138 or the like, such as in a relational database in which historical rapport data is grouped or linked according to the identity of the participants of the past contact. For example, rapport score data store 138 may store historical rapport data for a number of contacts in which an agent was a participant and may, in response to a query, provide the historical rapport data for all such contacts.

Rapport score determiner 118 may further be operable to analyze historical rapport data to provide useful historical metrics associated with the rapport data. For example, rapport score determiner 118 may access the historical rapport data to calculate historical trends or averages for the historical rapport data, which may be useful in assessing historical rapport for certain agents, customers, or other contact participants. In one non-limiting example, a rapport score average may be determined for an agent. In another non-limiting example, a rapport score trend may be determined for that same agent, where a positive rapport score trend indicates increasing rapport score values over time and a negative rapport score trend indicates that the agent's rapport scores have been decreasing over time. Additionally, or alternatively, similar averages or trend data may be determined for an agent for individual rapport metrics. For example, rapport score determiner 118 may access the historical rapport data and determine agent performance for particular topics or categories during contacts over a period of time. As an example, rapport score determiner may identify all contacts within the historical rapport data in which a particular agent participated in a contact addressing a certain topic and, from those contacts, calculate an average, trend, or other value representing agent performance over time in that particular subject area. In another non-limiting example rapport score determiner may further be operable to analyze historical rapport data for groups of contact participants, such as by determining averages, trends, or other values representing rapport score performance for a department, team, or group level.

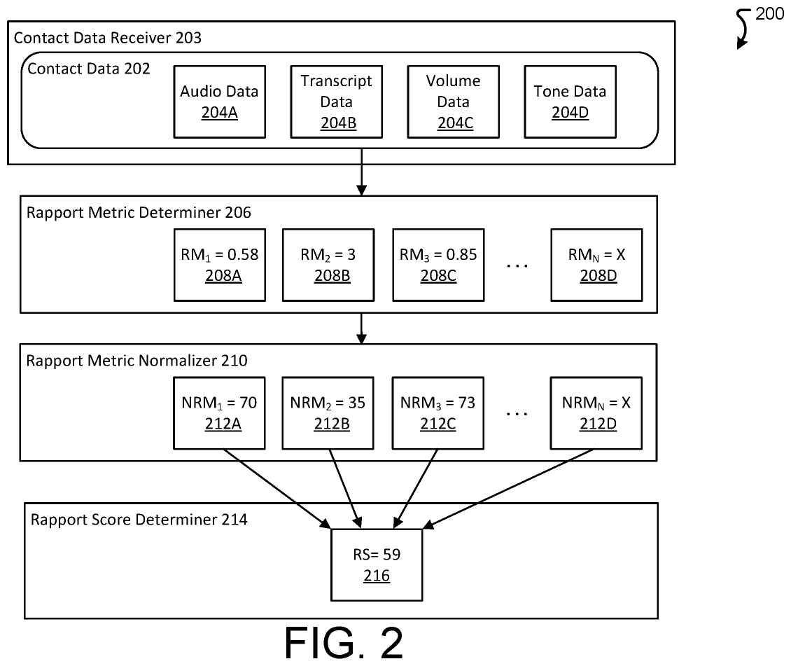

FIG. 2 illustrates an exemplary system 200 for determining a rapport score based on contact data in accordance with aspects of the present disclosure. The system includes contact data 202 received by contact data receiver 203. Contact data 202 may include any one or more of audio data 204a, transcript data 204b, volume data 204c, tone data 204d, or other various forms of data relating to a contact and which may be used to describe the content of that contact. Contact data 202 may further include metadata associated with the contact, such as metadata indicating a queue from which a contact was generated (e.g., a queue for contacts relating to billing issues). Contact data may further include metadata relating to the participants of a contact, such as metadata indicating how long an agent has been employed or indicating that an agent has previously received training or certification in a particular area. Contact Data receiver may be operable to receive audio data 204a and, from the audio data 204a, generate associated transcript data 204b, volume data 204c, and tone data 204d using audio processing techniques known in the art. The type of contact data 202 received by contact data receiver 203 may depend, at least in part, on the type of contact associated with the contact data 202. For example, a contact that occurs over a phone interface or other similar connection may include audio data 204, volume data 204c, and tone data 204d, while a contact that occurs over a chat or email interface may include transcript data 204b but not audio data 204a.

Rapport metric determiner 206 receives contact data 202 from contact data receiver 203. Using the contact data 202, rapport metric determiner 206 determines one or more rapport metrics associated with the contact. In the example FIG. 2, rapport metric determiner 206 is depicted as determining a first rapport metric RM₁ 208a, a second rapport metric RM₂ 208b, and a third rapport metric RM₃ 208c. As will be appreciated, rapport metric determiner 206 may determine any number of rapport metrics for a given set of contact data 202, up to and including rapport metric RM_{N} 208d. The number and type of rapport metrics determined from a given set of contact data 202 may depend on the type of contact data 202 received. For instance, certain rapport metrics may be available only when audio data 204a is received, while others may be available only when transcript data 204b is received. Rapport metric determiner 206 may, based on the contact data 202 received from contact data receiver 203, determine which rapport metrics to determine based on the type and/or quality of contact data 202 received.

In aspects, a rapport metric is a numerical value representing a measure of rapport between participants in a contact. Rapport metric determiner 206 may determine a single rapport metric or a plurality of different rapport metrics from the contact data for a given contact, with each rapport metric measuring an aspect of the rapport between the participants for the contact. While the present disclosure is not limited to any specific rapport metrics, certain example rapport metrics are provided herein to illustrate the types and variety of rapport metrics that may be used by rapport metric determiner 206.

For example, in the illustrative system 200 depicted in FIG. 2, first rapport metric RM₁ 208a relates to relative speaking time of participants during a contact. Such a rapport metric may measure the relative time spent by each participant in a contact contributing to the contact, such as by speaking, typing, or the like. In this example, the rapport metric may be a number, such as a percentage or decimal, indicating a participant's relative contribution to the contact. For example, the rapport metric may be a number between 0 and 1 (though other ranges or classifications can be used) indicating an amount of time during which a participant was speaking during a contact, divided by the total length of the contact. As depicted in FIG. 2, first rapport metric RM₁ 208a is 0.58, which may indicate that an agent contributed 58% of the content of a contact.

In the illustrative system 200, second rapport metric RM₂ may relate to a number or rate of interruptions during a contact. In this example, the rapport metric may be a number of interruptions detected in the contact data. The number of interruptions may be based on an analysis of audio data, transcription data, or any other contact data. The rapport metric may also indicate a rate of interruptions during a contact, such as by dividing the number of interruptions by a length of the contact or total volume of content exchanged between participants during the contact. In this way, the rapport metric may reflect the expectation that a longer contact or a contact with a higher volume of content may have a higher number of total detected interruptions compared to a shorter contact or a contact with a lower volume of content. As depicted in FIG. 2, second rapport metric RM₂ 208b is 3, which may, for example, indicate that an agent interrupted a customer 3 times during a call or, alternatively, may indicate that an agent interrupted a customer at a rate of 3 interruptions per hour.

In the illustrative system 200, third rapport metric RM₃ 208c may relate to a mirroring metric that is operable to analyze the contact data using techniques to determine or approximate the extent to which one participant matches (or “mirrors”) the statements (e.g., the voice tone) of another participant. In such an example, the contact data may include audio files having voice tone data that can be input to the mirroring model to determine the extent of mirroring during a contact. As depicted in FIG. 2, third rapport metric RM₃ 208c is 0.85. This numerical value, or any other value produced as a result of the rapport metric determiner 206 determining a third rapport metric RM₃ 208c based on an mirroring model, may indicate the similarity between features in the contact data. In such examples, the mirroring metric may approximate how well one contact participant (e.g., an agent) is mirroring another participant (e.g., a customer) by using the cosine similarity between vectorized pairs of statements/responses by the participants during the contact.

Rapport metric normalizer 210 receives rapport metrics, such as RM₁ 208a, RM₂ 208b, and RM₃ 208c, from rapport metric determiner 206. Rapport metric normalizer 210 may receive each rapport metric determined by rapport metric determiner 206 for a given set of contact data 202. Alternatively, rapport metric normalizer 210 may receive a subset of the rapport metrics determined by rapport metric determiner 206. For instance, rapport metric normalizer 210 may receive the rapport metrics for which the rapport metric determiner 206 has the highest degree of confidence in the accuracy and/or usefulness of the rapport metric. Thus, although not pictured in illustrative FIG. 2, it will be appreciated that one or more of the rapport metrics determined by rapport metric determiner 206 may further include or be associated with a confidence value or the like. In another example, rapport metric normalizer 210 may receive the rapport metrics for which the rapport metric deviation exceeds a threshold value, such as the rapport metrics that deviate from an associated rapport metric target by 10% or more.

For the rapport metrics received by the rapport metric normalizer 210, rapport metric normalizer 210 normalizes the received rapport metrics. As discussed above, a rapport metric determined by the rapport metric determiner 206 may be a numerical value. In certain instances, though, the numerical value lacks appropriate context to assess the meaning of the rapport metric with respect to the measure of rapport for a given contact. Thus, in at least some cases, it may be appropriate for rapport metric normalizer 210 to employ certain techniques to place the rapport metric in useful context by normalizing the rapport metric.

It will be appreciated that there are a number of techniques that may be implemented by rapport metric normalizer 210 to normalize the rapport metrics. In one non-limiting example, rapport metric normalizer 210 normalizes one or more rapport metrics by comparing the rapport metrics to target rapport metrics. In other examples, rapport metric normalizer 210 normalizes one or more rapport metrics by comparing the rapport metrics to historical data from past contacts for which rapport metric determiner 206 has determined historical rapport data, such as the same or similar rapport metrics for a past contact. In another example, rapport metric normalizer 210 normalizes one or more rapport metrics by applying a normalization function to the rapport metric. The technique or techniques used to normalize a rapport metric may depend on the rapport metric, such that rapport metric normalizer 210 may employ more than one technique to normalize rapport metrics received for a given set of contact data 202.

In aspects, the normalized rapport metric may be a numerical value, such as a numerical value between 0 and 1 or between 0 and 100. The normalized rapport metric may indicate the extent to which the rapport metric deviates—or, conversely, does not deviate—from a target rapport metric. For example, a normalized rapport metric may be inversely correlated with the rapport metric deviation, such that a higher normalized rapport metric indicates a lower degree of deviation from the target rapport metric. That is, a rapport metric that is closer to its associated target rapport metric would lead to a higher normalized rapport metric, while a rapport metric that is further from its target would lead to a lower normalized rapport metric.

In the illustrative system 200 of FIG. 2, rapport metric normalizer 210 normalizes the first rapport metric RM₁ 208a to produce a normalized first rapport metric NRM₁ 212a. For example, first rapport metric RM₁ 208a may indicate that an agent contributed 58% of the content of a given contact. Rapport metric normalizer 210 may, based on retrieving a rapport metric relating to relative speaking/typing time, determine a target rapport metric associated with the first rapport metric. As an example, rapport metric normalizer 210 may determine that the target rapport metric for the first rapport metric is 0.50, indicating that the ideal (or “target”) amount for an agent to contribute to a contact for maximum rapport is 50% of the contact (e.g., suggesting that an agent and customer contributed equal amounts to a contact). Based on determining the target rapport metric of 0.50, rapport metric normalizer 210 may determine a normalized first rapport metric of 70. In such an example, the normalized rapport metric may represent a value between 1 and 100 indicating the relative strength of a given rapport metric, with 1 indicating minimum rapport for that rapport metric and 100 indicating maximum rapport for that rapport metric. For instance, a hypothetical first rapport metric value of 0.50—which is the same as the example target rapport metric given above—may produce a normalized rapport metric of 100, indicating that the rapport metric is equal or substantially equal to the “ideal” target value for that rapport metric. In the example FIG. 2, the normalized first rapport metric 212a is shown having a value of 70, indicating that the first rapport metric is relatively close to the target for the first rapport metric but also leaves room for improvement.

In a similar way, rapport metric normalizer 210 normalizes second rapport metric RM₂ 208b to produce a normalized second rapport metric NRM₂ 212b. In the example described above, second rapport metric RM₂ 208b indicates an interruption count and/or interruption frequency from a given set of contact data 202. Rapport metric normalizer 210 normalizes second rapport metric RM₂ 208b by applying one or more of the multiple possible normalization techniques contemplated herein. For instance, rapport metric normalizer 210 may determine a target second rapport metric for the interruption-related second rapport metric RM₂ 208b. As an example, the target second rapport metric may be zero, indicating that the amount or rate of interruption during a contact should ideally be zero to maximize rapport between contact participants. In the example depicted, the second rapport metric RM₂ 208b is 3, indicating an interruption amount or rate that is greater than desired for that rapport metric. Using the second rapport metric RM₂ 208b and any additional normalization data that may be helpful in normalizing the rapport metric (e.g., the target second rapport metric, the amount of deviation from the target, historical rapport data related to past contacts, or the like) rapport metric normalizer 210 produces a normalized second rapport metric NRM₂ 212b of 35, indicating that the interruption amount or frequency determined by rapport metric determiner 206 is moderately poor.

In a similar way, rapport metric normalizes third rapport metric RM₃ 208c to produce a normalized third rapport metric NRM₃ 212c. In the depicted example the third rapport metric RM₃ 208c value of 0.85 produces a normalized third rapport metric NRM₃ 212c of 73, indicating that the third rapport metric (in this example, output generated by a mirroring model) suggests a moderately positive performance for that metric based on the contact data 202. As shown in FIG. 2 and described herein, it will be appreciated that the numerical values produced by rapport metric determiner 206 for multiple rapport metrics may not immediately indicate the relative performance of that rapport metric, but the normalized rapport metrics produced by rapport metric normalizer 210 may, using the normalization techniques contemplated and described herein, provide a better “apples to apples” comparison of the performance of those rapport metrics. For example, the first rapport metric value of 0.58 and third rapport metric value of 0.85 may seem to be dissimilar values, but after application of normalization techniques by rapport metric normalizer 210, may indicate that both the first rapport metric and the third rapport metric indicate a moderately positive rapport. It will further be appreciated that rapport metric normalizer 210 may produce a normalized rapport metric for some, all, or none of the received rapport metrics, up to and including RM_{N} 208d, for which rapport metric normalizer 210 produces a NRM_{N} 212d.

Rapport score determiner 214 determines a rapport score, which may indicate the overall rapport performance across a number of rapport metrics determined for a given set of contact data 202. As shown in FIG. 2, each of the normalized rapport metrics produced by rapport metric normalizer 210 may be received by rapport score determiner 214 and used to create a single rapport score 216. In the example depiction, the rapport score 216 produced from the first, second, and third normalized rapport metrics 212a-c is a value of 59. In aspects, rapport score determiner 214 produces a rapport score 216 by combining the values of the normalized rapport metrics.

It will be appreciated that there are several techniques that may be employed by rapport score determiner 214 to combine the normalized rapport metrics and produce a rapport score 216. In one example, it may be determined that a high frequency of interruptions during a contact is highly correlated with low rapport between participants in a contact, while the ratio of speaking/typing time has a weaker correlation with the rapport between contact participants. In such a non-limiting example, rapport score determiner 214 may, when determining the rapport score for the contact, give greater consideration to a first rapport metric measuring interruption frequency compared to a second rapport metric measuring relative speaking/typing time. One exemplary technique that rapport score determiner 214 may employ in such an instance is to determine a rapport score using a weighted average of the received rapport metrics. Rapport score determiner 214 may receive weighting values (or “weights”) (not shown in FIG. 2) associated with each of the received normalized rapport metrics. In aspects, the weighting values are based on a relative importance attributed to a given rapport metric to the overall rapport for a given contact. Additionally or alternative, weighting values may be based on a confidence value associated with a determined rapport metric, such as a confidence value produced by rapport metric determiner 206 indicating the rapport metric determiner's 206 confidence in the accuracy and/or reliability of the rapport metric determined for a given set of contact data 202. The rapport score determiner 214 may use these rapport score weights to generate a weighted combination (e.g., a weighted average) from the received normalized rapport metrics, which can be used as a rapport score for the contact.

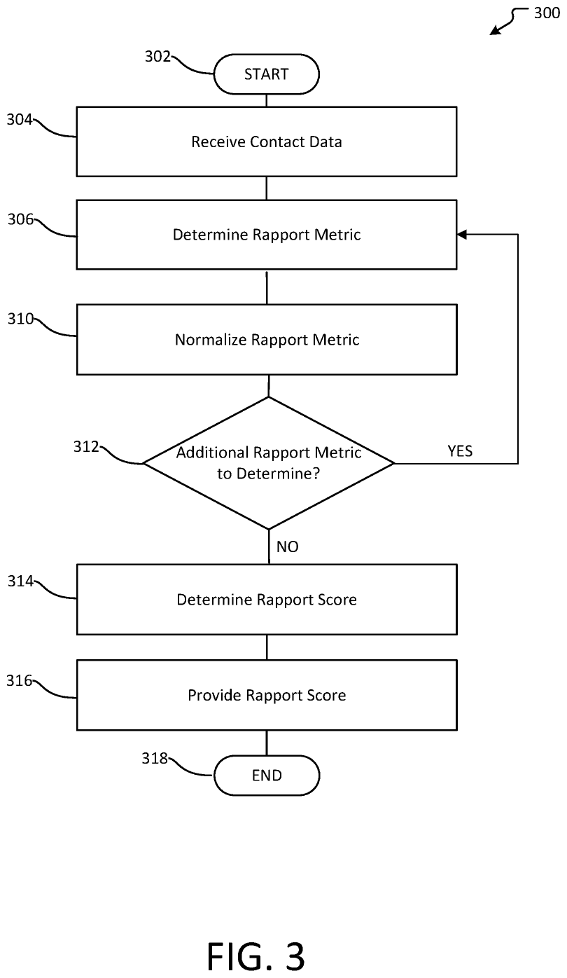

FIG. 3 illustrates an exemplary method 300 for determining and providing a rapport score based on contact data. A general order of the operations for the method 300 is shown in FIG. 3. Generally, the method 300 begins with start operation 302 and end with end operation 320. The method 300 may include more or fewer steps or may arrange the order of the steps differently than those shown in FIG. 3. The method 300 can be executed as a set of computer-executable instructions executed by a cloud system and encoded or stored on a computer readable medium. Further, the method 300 can be performed by gates or circuits associated with a processor, an ASIC, an FPGA, a SOC or other hardware device. Hereinafter, the method 300 shall be explained with reference to the systems, components, devices, modules, software, data structures, data characteristic representations, signaling diagrams, methods, etc., described herein.

Following start operation 302, the method begins with receive operation 304, which receives contact data associated with a contact. In aspects, the contact may be a contact that has completed. In other aspects, the contact may be an ongoing contact. A contact receiver (e.g., the contact data receiver 112 as shown in FIG. 1) may receive the contact data from a computer terminal being used by an agent at a contact center or a server at a contact center. In aspects, the contact data may include information associated with speakers of a contact, time, and date of the contact, a duration of the contact, an audio recording of the contact, a transcription of the contact, and the like.

Determine operation 306 determines a rapport metric from the contact data. In aspects, the determine operation analyzes the contact data to determine a metric relating to some aspect of the rapport between participants in the contact. As will be appreciated and as described herein, determine operation 306 may select from a number of different rapport metrics to determine. The rapport metric determined may depend on the type, quality, or other characteristics of the contact data received and available for analysis.

Normalize operation 310 normalizes a rapport metric determined in determine operation 306. Normalize operation 310 may employ any one or more of the normalization techniques contemplated herein. For example, normalize operation 310 may include receiving or retrieving a target rapport metric associated with the rapport metric determined at determine operation 306. Normalize operation 310 may further include comparing the rapport metric determined at determine operation 306 to the target rapport metric and, in some cases, determining the extent to which the rapport metric deviates from the target rapport metric. Normalize operation 310 may further include using a rapport metric or a rapport metric deviation to determine a normalized rapport metric, which may be a value ranging from 0 to 1, 0 to 100, or any other numerical range. Additionally or alternatively, normalize operation 310 may include applying a normalization function to a rapport metric or a rapport metric deviation to determine a normalized rapport metric. Additionally or alternatively, normalize operation 310 may include receiving or retrieving historical rapport data associated with past contacts and comparing a rapport metric or a rapport metric deviation to historical rapport data to determine a normalized rapport metric. Decision operation 312 determines whether there is an additional rapport metric to be determined from the contact data. In some cases, determine operation 306 is configured to determine more than one rapport metric from the contact data.

If it is desired to determine more than one rapport metric from the contact data, method 300 proceeds along the “YES” decision flow to return to determine operation 306 for determination of the additional rapport metric. The additional rapport metric can then be normalized in the same or similar manner as described above in normalize operation 310. Although FIG. 3 depicts decision operation 312 occurring after normalize operation 310, it will be appreciated that when there are multiple rapport metrics to be determined at determine operation 306, the rapport metrics may be determined sequentially, in parallel, in batches, or in any other similar manner.

If decision operation 312 determines that all desired rapport metrics have been determined for the contact data, method 300 proceeds to determine operation 314. Determine operation 314 determines a rapport score based on the one or more rapport metrics determined at determine operation 306 and/or the one or more normalized rapport metrics produced at normalize operation 310. As described herein, a rapport score indicates a level of overall rapport during a contact with which the received contact data is associated. For example, a rapport score may be a numerical value, such as a value from 1 to 100 or any other suitable range. Alternatively, a rapport score may be a non-numerical value, such as a letter grade assigned to a given contact. In the case of a contact that is ongoing, a rapport score may be identified as a partial rapport score, which may reflect a current rapport score based on the partial contact data that has been analyzed for the contact or may reflect a projected rapport score based on a projection of what the rapport score will be for the contact based on a projection of what rapport metrics for the contact will be at the termination of the contact. Determine operation 314 may determine a rapport score by combining one or more rapport metrics and/or normalized rapport metrics. In aspects, determine operation 314 combines one or more rapport metrics and/or normalized rapport metrics by receiving weights associated with the one or more rapport metrics and/or normalized rapport metrics and combining according to the received weights. For example determine operation 314 may receive a weight associated with each received rapport metric and/or normalized rapport metric determined by determine operation 306 and normalize operation 310, respectively, and based on the weights, compute a weighted average of the rapport metrics to produce a rapport score.

Although a rapport score is described herein as indicating an overall level of rapport for a contact, it will be appreciated that in some cases there may be more than one rapport score associated with a given contact, such as a rapport score assigned to each participant in a contact or a rapport score assigned to different subjects addressed during a contact. For example, in a contact in which an agent addresses two separate customer topics, method 300 and determine operation 314 may determine a separate rapport score for each of the addressed topics, such that there would be more than one rapport score associated with the contact in question.

Provide operation 316 provides the one or more rapport scores determined at determine operation 314. Providing the rapport score may include transmitting the rapport score over a network (such as network 140 of FIG. 1). Additionally or alternatively, providing the rapport score may include storing the rapport score in a database (such as rapport score data store 138 of FIG. 1). In aspects, providing the rapport score may entail presenting the rapport score on a display (such as the display of computer terminal 104 or client-computer device 102 depicted in FIG. 1).

When a rapport score is stored, transmitted, displayed or otherwise provided at provide operation 316, it may be accompanied by rapport data associated with past contacts (or “historical rapport data”). The historical rapport data may include, for example, rapport metrics and rapport scores from prior contacts that have been processed according to method 300.

As should be appreciated, operations 302-318 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

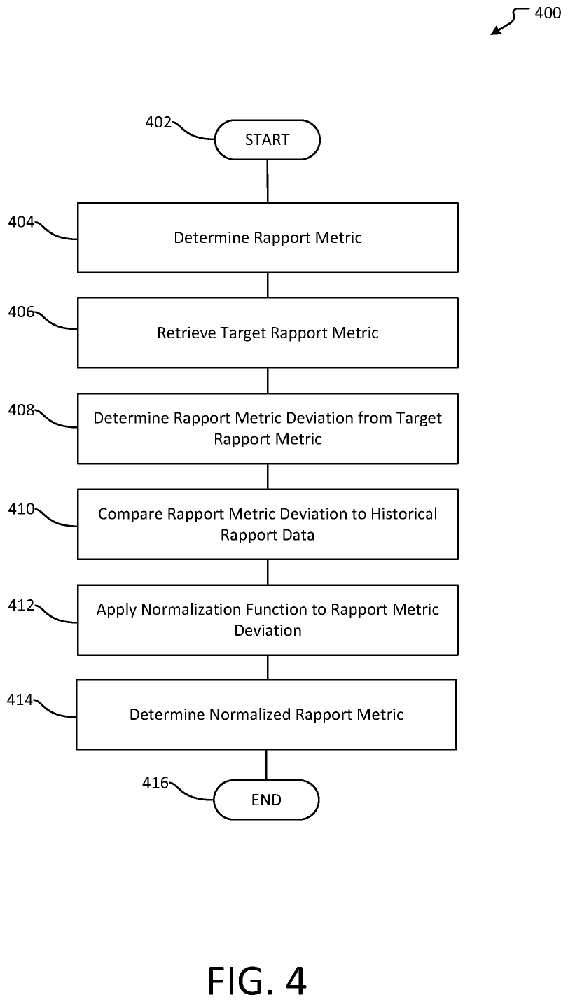

FIG. 4 illustrates an exemplary method 400 for determining a normalized rapport metric. A general order of the operations for the method 400 is shown in FIG. 4. Generally, the method 400 begins with start operation 402 and end with end operation 416. The method 400 may include more or fewer steps or may arrange the order of the steps differently than those shown in FIG. 4. The method 400 can be executed as a set of computer-executable instructions executed by a cloud system and encoded or stored on a computer readable medium. Further, the method 400 can be performed by gates or circuits associated with a processor, an ASIC, an FPGA, a SOC or other hardware device. Hereinafter, the method 400 shall be explained with reference to the systems, components, devices, modules, software, data structures, data characteristic representations, signaling diagrams, methods, etc., described herein.

Following start operation 402, the method begins with determine operation 404, which determines a rapport metric. In aspects, determining a rapport metric involves analyzing contact data associated with a contact as described elsewhere herein (e.g., in connection with rapport metric determiner 114 of FIG. 1). Although FIG. 4 depicts a method 400 in which determiner operation 404 determines a single rapport metric, it will be appreciated that determiner operation 404 may determine a plurality of rapport metrics, each of which relates to a different aspect of rapport during a contact. Several non-limiting examples of the type of rapport metrics that may be determined at determine operation 404 are provided herein.

Retrieve operation 406 retrieves a target rapport metric. In aspects, the target rapport metric retrieved at retrieve operation 406 is a target rapport metric associated with the rapport metric determined at determine operation 404. In some aspects, each rapport metric determined at determine operation 404 is associated with a unique target rapport metric indicating an optimal or ideal value for the rapport metric that is understood to represent the value of that rapport metric that would indicate the best possible rapport between participants during a contact. In other aspects, the target rapport metrics retrieved at retrieve operation 406 may be the same or similar for different rapport metrics. Further, as discussed herein, a target rapport metric associated with a rapport metric may be changed, calibrated, or otherwise adjusted over time, such that the target rapport metric retrieved at retrieve operation 406 may be different at one point in time for a given rapport metric than it was at another point in time for the same rapport metric. Retrieve operation 406 may be performed as part of a normalization of a rapport metric, such as the normalization performed by rapport metric normalizer 116 of the system 100 in FIG. 1. In such an instance, retrieval of a target rapport metric may be used to normalize a rapport metric to provide for more useful analysis and/or comparison of that rapport metric, such as for use in determining a rapport score for a contact.

Determine operation 408 determines whether—and, if so, to what extent—the rapport metric determined by determine operation 404 deviates from the associated target rapport metric retrieved at retrieve operation 406. Determiner operation 408 may determine such a rapport metric deviation by, for example, subtracting or dividing the rapport metric from/by the target rapport metric. In this way, determine operation 408 may produce a rapport metric deviation value that represents an amount and/or a percentage difference between the rapport metric and the rapport metric target. It will be appreciated, though, that the absolute difference and percentage difference are only two examples of a rapport metric deviation value and that any other rapport metric deviation may be determined at determine operation 408 such that the rapport metric deviation value provides an indication or representation of the amount, direction, or extent to which the rapport metric deviates from the target rapport metric. The rapport metric deviation produced at determine operation 408 may itself be a normalized rapport metric or may be used to determine a normalized rapport metric.

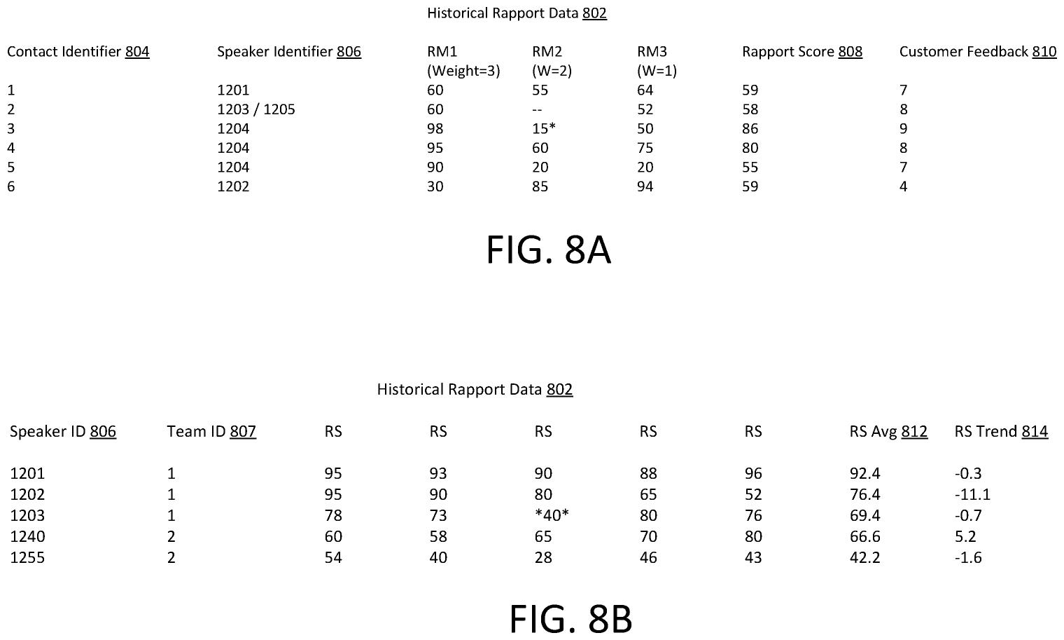

Compare operation 410 compares a rapport metric deviation to historical rapport data. As used herein, historical rapport data may include, for example, information relating to past contacts for which contact data has been processed according to the systems and methods described herein to determine one or more aspects of rapport for the contact. That is, historical rapport data may include rapport metrics, normalized rapport metrics, rapport scores, rapport score averages, rapport score trends, customer feedback data, or any other measure of rapport from past contacts based on analysis of contact data. The historical rapport data may further include indications of the time, location, and identity of participants in the contact. In this way, historical rapport data represents an accessible, searchable, and comprehensive accumulation of past inputs and outputs of the systems and methods described herein. Examples of the type and format of historical rapport data are provided in greater detail in connection with FIG. 8A and FIG. 8B below.

Compare operation 410 may compare a rapport metric deviation to historical rapport data to determine how a rapport metric deviation for a given contact compares to the same or similar measure for past contacts. For example, for a first rapport metric determined by determine operation 404, compare operation 410 may compare the deviation of that rapport metric from an associated target rapport metric to historical rapport metric deviation data for that same rapport metric. As an example, if determine operation 408 determines that the rapport metric deviation for the contact in question is 15%, compare operation 410 may compare this deviation value to the historical rapport metric deviation data to determine that over a set of past contacts, the median rapport metric deviation for this same rapport metric is 10%. In such an example, compare operation 410 determines that the rapport metric deviation of the present contact is higher than the median rapport metric deviation for past contacts, indicating that the rapport metric for the present contact is further from its associated target value than it has historically been for past contacts.

Additionally or alternatively, compare operation 410 may compare the rapport metric deviation to historical rapport data to generate a value that indicates how the present rapport metric deviation compares to comparable historical data. As an example, compare operation 410 may determine a percentile value indicating the relative performance of the present rapport metric deviation compared to historical rapport metric deviations for the same rapport metric. In the example above, in which the rapport metric deviation for the present contact is 15% and the median historical rapport metric deviation for the same rapport metric is 10%, it may further be determined that the rapport metric deviation of 15% falls into the 40^{th} percentile of rapport metric deviations for that particular rapport metric. That is, the rapport metric deviation of 15% is smaller than 40 percent of the comparable contacts to which it is being compared but larger than 60 percent of those comparable contacts. This type of percentile or any other similar comparison value may be useful to indicate the relative performance of the participants in a contact compared to participants in comparable contacts that occurred in the past and for which there is historical rapport data. The comparison value produced at compare operation 410 may itself be a normalized rapport metric or may be used to determine a normalized rapport metric.

Apply operation 412 applies a normalization function to a rapport metric deviation. As described in connection with rapport metric normalizer 116 of FIG. 1, a normalization function may be a mathematical operation or set of operations to which a rapport metric deviation is an input and which is implemented to transform a rapport metric deviation into a value or values that can be used as a measure of relative performance for the rapport metric. A rapport metric normalization function may be the same for different rapport metrics or, alternatively, may be different for different rapport metrics. For instance, it may be determined that for a first rapport metric it is not uncommon or particularly concerning to see relatively large deviations from the target rapport metric. On the other hand, for a second rapport metric, it may be determined that even the smallest deviations for a second rapport metric indicate a severe deterioration in rapport for a contact. Thus, the first and second rapport metrics may have different normalization functions that impose an appropriate penalty for deviations from the target. Apply operation 412 may, thus, determine an appropriate normalization function to apply based on the specific rapport metric determined at determine operation 404 and apply the appropriate normalization function to the rapport metric deviation determined at determine operation 408. The output of the normalization function produced at apply operation 412 may itself be a normalized rapport metric or may be used to determine a normalized rapport metric.

Operation 414 determines a normalized rapport metric. As described above, the values produced at operations 408, 410, 412 may, in some aspects, themselves be considered normalized rapport metrics. In such aspects, determine operation 414 may receive the output(s) of one or more of those operations and determine the output(s) to be a normalized rapport metric for the rapport metric determined at determine operation 404. In some cases, only one of operations 408, 410, and 412 may be performed, such that determine operation 414 receives only a single output from those operations, which is itself determined to be the normalized rapport metric.

In other cases, more than one of operations 408, 410, 412 or the like may be performed, in which case determine operation 414 may receive more than one output. In the event that more than one of operations 408, 410, 412 produces an output, determine operation 414 may receive and process the outputs of those operations to determine a normalized rapport metric. For example, determine operation 414 may select a single one of the outputs of operations 408, 410, and 412 as a normalized rapport metric. Such a selection may, for example, be based on information received along with the outputs that may be used to determine which of the outputs would serve as the best normalized rapport metric. For example, compare operation 410 may generate or identify information about the comparison of the rapport metric deviation to historical rapport data, such as the number of comparable past contacts in the historical rapport data. In some cases, there may be a limited number of comparable past contacts in the historical rapport data, which might indicate that the comparison produced by compare operation 410 has limited or reduced value as an indication of relative performance.

Additionally or alternatively, determine operation 414 may receive more than one output from operations 408, 410, 412 and, rather than selecting an individual one of the outputs to serve as a normalized rapport metric, may combine the outputs to produce a normalized rapport metric. For example, determine operation 414 may determine a normalized rapport metric by taking an average of the outputs of operations 408, 410, and/or 412. In another example, determine operation 414 may first remove any outlier values before taking an average of outputs of operations 408, 410, and/or 412. As will be appreciated, when taking an average or other combination of outputs of operations 408, 410, and/or 412, determine operation 414 may apply various techniques to weight or otherwise filter or adjust the outputs prior to analysis to determine a normalized rapport metric.

As should be appreciated, operations 402-416 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

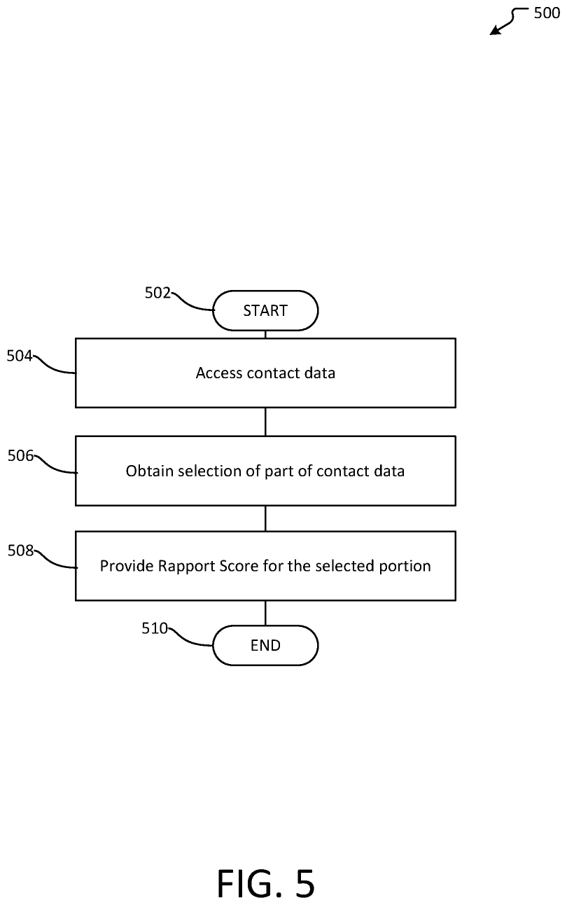

FIG. 5 illustrates an exemplary method 500 for providing a rapport score for a selected portion of contact data. A general order of the operations for the method 500 is shown in FIG. 3. Generally, the method 500 begins with start operation 502 and end with end operation 510. The method 500 may include more or fewer steps or may arrange the order of the steps differently than those shown in FIG. 5. The method 500 can be executed as a set of computer-executable instructions executed by a cloud system and encoded or stored on a computer readable medium. Further, the method 500 can be performed by gates or circuits associated with a processor, an ASIC, an FPGA, a SOC or other hardware device. Hereinafter, the method 500 shall be explained with reference to the systems, components, devices, modules, software, data structures, data characteristic representations, signaling diagrams, methods, etc., described herein.

Following start operation 502, the method begins with access operation 504, which accesses contact data. In aspects, contact data may be received from one or more of client computing devices, a network, a computer terminal used for participating in contacts, and a server (e.g., a virtual assistant server).

Obtain operation 506 obtains a selection of contact data. In aspects, the part of contact data may include a predefined portion of a contact (e.g., beginning, middle and/or toward the end of the call). In some aspects, the portion of the contact may be specified by a particular user. In aspects, the portion of the contact may be obtained based upon a query for specific information associated with one or more parts of the call. In doing so, the method 500 provides a way for a user to query contact data in order to identify specific portions of contacts based, for example, on a rapport score for a portion of a contact or changes in rapport score during a contact. Thus, for a contact having a low overall rapport score, a user may be able to determine a point at which a rapport shifted from good to bad and identify the cause or causes for that shift.

Provide operation 508 provides a rapport score for selection portion of the contact to a requesting device.

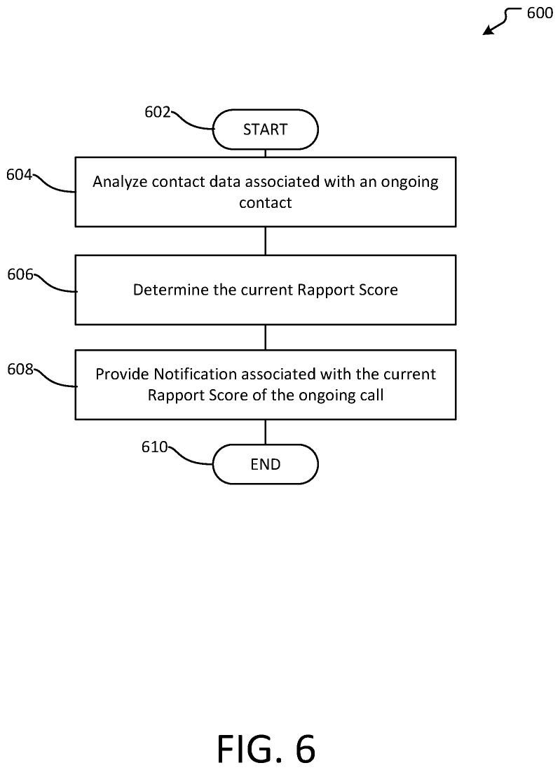

FIG. 6 illustrates an exemplary method for determining a rapport score and providing a notification during an ongoing call. A general order of the operations for the method 600 is shown in FIG. 6. Generally, the method 600 begins with start operation 602 and ends with end operation 610. The method 600 may include more or fewer steps or may arrange the order of the steps differently than those shown in FIG. 6. The method 600 can be executed as a set of computer-executable instructions executed by a cloud system and encoded or stored on a computer readable medium. Further, the method 600 can be performed by gates or circuits associated with a processor, an ASIC, an FPGA, a SOC or other hardware device. Hereinafter, the method 600 shall be explained with reference to the systems, components, devices, modules, software, data structures, data characteristic representations, signaling diagrams, methods, etc., described herein.

Following start operation 602, the method begins with analyze operation 604, which analyzes contact data associated with an ongoing contact. In aspects, the contact data may include data associated with more than one ongoing contacts. The analyze operation 604 may analyze the contact data by receiving a request for analyzing the contact data by specifying a particular contact to analyze.

Determine operation 606 determines the current rapport score associated with the ongoing contact. In aspects, the current rapport score may be based on the determination of one or more rapport metrics from the contact data. In other aspects, the current rapport score may be based on the determination of one or more normalized rapport metrics from the contact data. In still other aspects, the current rapport score may be a combination, such as a weighted average or an average, of one or more rapport metrics for received contact data. Determine operation 606 may further determine a projected rapport score associated with the ongoing contact, where the projected rapport score indicates an approximation or projection of what the rapport score is likely to be when the contact terminates. Such a projected rapport score may be based on, for example, a projection of what individual rapport metrics for the contact will be when the contact terminates (e.g., based on a current rate or count of a given rapport metric measurement).

Provide operation 608 provides a notification associated with the current rapport score of the ongoing contact. In aspects, the provide operation 608 transmits the notification to one or more of the client computing devices, such as a computing terminal used by an agent of a support call center, a manager, and/or a virtual assistant. In certain aspects, the notification may be provided in response to certain triggers, such as detection of a low rapport score, detecting a negative trending rapport score, a change in rapport score in general, or any other type of rapport change that the agent and/or manager is interested in. Moreover, the method 600 may be customizable by different users to provide notifications based upon conditions or factors of interest to a particular user.

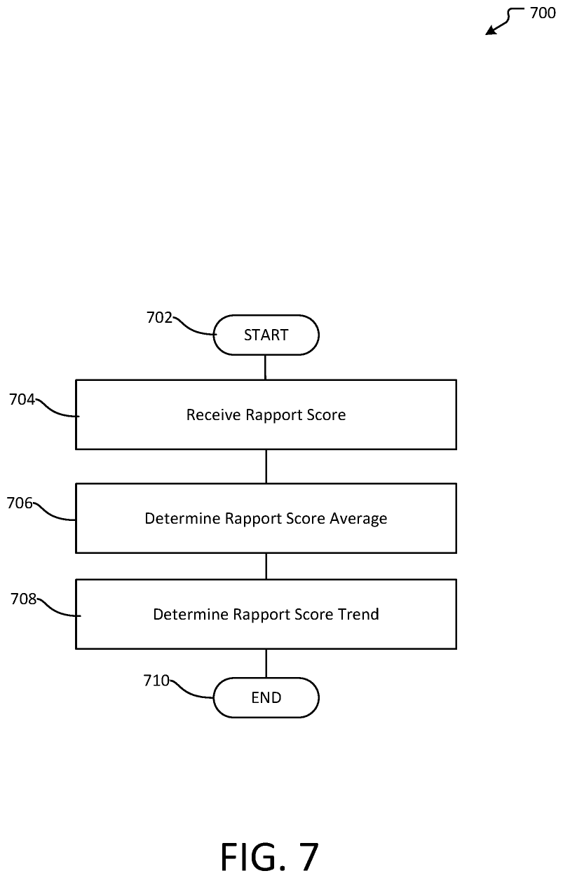

FIG. 7 illustrates an exemplary method for determining and storing a rapport score and rapport score data. A general order of the operations for the method 700 is shown in FIG. 7. Generally, the method 700 begins with start operation 702 and end with end operation 710. The method 700 may include more or fewer steps or may arrange the order of the steps differently than those shown in FIG. 7. The method 700 can be executed as a set of computer-executable instructions executed by a cloud system and encoded or stored on a computer readable medium. Further, the method 700 can be performed by gates or circuits associated with a processor, an ASIC, an FPGA, a SOC or other hardware device. Hereinafter, the method 700 shall be explained with reference to the systems, components, devices, modules, software, data structures, data characteristic representations, signaling diagrams, methods, etc., as described in herein.

Following start operation 702, the method begins with receive operation 704, which receives a rapport score. The rapport score received at receive operation 704 may be a rapport score determined according to any one or more of the systems and methods described herein, such as by rapport score determiner 118 of system 100 and/or by operation 314 of method 300. Receive operation 704 may be performed by the same computing device that determines a rapport score or, alternatively, may be performed by a computing device remote from the computing device responsible for determining the rapport score. In the latter case, the rapport score may be transmitted to the receiving computing device via the Internet or other comparable network, such as network 140 of system 100. Receive operation 704 may include receiving a rapport score associated with a contact or may include receiving a plurality of rapport scores associated with a number of contacts. The rapport score(s) received at receive operation 704 may include not only one or more rapport scores but also additional identifiers associated with the rapport scores and useful in associating the rapport scores with their associated contacts and with the participants to those contacts. For example, each received rapport score may be accompanied by a contact identifier identifying the contact associated with the rapport score, as well as one or more speaker identifiers identifying the participants in the contact.

Determine operation 706 determines a rapport score average. To determine a rapport score average, determine operation 706 may include accessing a store of historical rapport data, which as discussed elsewhere herein, may include data from past contacts relating to rapport metrics and rapport scores for those contacts. Determine operation 706 may determine a rapport score average based on the receipt of new rapport score data, such as a new rapport score or set of rapport scores received at receive operation 704. For example, receive operation 704 may receive a new rapport score for a newly completed contact, along with a contact identifier and speaker identifiers for contact participants. In response to receiving the new rapport score, determine operation 706 may add the newly received rapport score to a rapport score data store. The addition of the rapport score may trigger the determination of a rapport score average, such as a rapport score average for the speaker(s) for whom the new rapport score has been received. For example, if the newly received rapport score reflects a rapport score for a participant having speaker identifier “1201,” determine operation 706 may identify all contacts in the data store associated with speaker “1201,” add the newly received rapport score to the data set of rapport scores associated with speaker “1201” and determine a rapport score average for all contacts in which speaker “1201” participated, including the contact for which a rapport score has been newly received.

Determine operation 708 determines a rapport score trend. In a similar manner as determine operation 706, determine operation 708 may determine a rapport score average based on the receipt of new rapport score data, such as a new rapport score or set of rapport scores received at receive operation 704. It will be appreciated that a rapport score trend is an indication of a change over time in the rapport scores associated with contacts involving a given contact participant, customer, topic, or other classification of contacts. For example a rapport score trend determined at determine operation 708 may indicate the trend of rapport scores for a particular agent over a specified number of recent contacts in which the agent participated, such that it would be possible to identify whether the rapport scores for those recent contacts have been increasing, decreasing, or staying the same over time. The rapport score trend may be customizable to reflect only a subset of most recent contacts, the entirety of contacts in the data store, or a specific selection of contacts. While determine operation 708 is shown in FIG. 7 as including a determination of a single rapport score trend, it will further be appreciated that determine operation 708 may include the determination of a plurality of rapport score trends, each reflecting a rapport score trend for a different subset of historical rapport data used to determine the trend, such as a different rapport score trend being determined for the last 10, 50, and 100 contacts in which an agent has participated.

FIG. 8A and FIG. 8B illustrate exemplary historical rapport data. The historical rapport data depicted in FIGS. 8A and 8B illustrate the type of historical rapport data that may be determined and provided according to the systems and methods contemplated and described herein. FIG. 8A provides historical rapport data 802 in a table format. The table of FIG. 8A may depict the format in which historical rapport data is stored in a data store (e.g., rapport score data score 138 of FIG. 1) after it has been determined according to any of the methods depicted in FIGS. 3-7. Additionally or alternatively, FIG. 8A may depict the format in which historical rapport data is presented to a user (e.g., in connection with provide operation 316 of method 300 in FIG. 3).

FIG. 8A includes contact identifiers 804. Contact identifier 804 indicates the contact with which the accompanying historical rapport data is associated. For instance, each contact for which contact data is processed by the systems and methods described herein may be associated with a unique contact identifier by which the system may differentiate between the data of different contacts.

FIG. 8A includes speaker identifier 806, which indicates one or more speakers associated with the contact identifier 804 in the same row. For instance, the speaker identifier “1201” in the first row having contact identifier “1” indicates that speaker 1201 participated in contact 1. As FIG. 8A shows, each contact may be associated with a single speaker identifier or with multiple speaker identifiers, such as contact identifier “6,” which is associated with both speaker identifier “1202” and speaker identifier “1205.” Further, historical rapport data 802 may include multiple contacts associated with the same speaker identifier, such as contacts “3” through “5”, each of which is associated with speaker “1204”, indicating that speaker “1204” participated in each of the contacts.

For the contacts identified in FIG. 8A, the historical rapport data 802 additionally includes rapport metrics. As shown, FIG. 8A includes a first, second, and third rapport metric, designated RM1, RM2, and RM3, respectively. It will be appreciated, however, that historical rapport data 802 may include any number of rapport metrics for any given contact identifier 804. It will further be appreciated that rapport metrics included in historical rapport data 802 may be rapport metrics, normalized rapport metrics, or both.

Moreover, for any given set of contact identifiers 804, certain of the contact identifiers may include rapport metrics that are not included in the historical rapport data for other contact identifiers. For instance, in the example FIG. 8A, contact identifier “2” does not include a second rapport metric RM2. This could be because the contact data associated with contact identifier “2” did not include sufficient data to determine the second rapport metric. Alternatively, it could be due to an administrator preference not to determine the second rapport metric for a certain agent, customer, or contact type.

In aspects, historical rapport data 802 may include rapport metrics for which the confidence of the rapport metric is below a confidence threshold. In such an instance, the historical rapport data 802 presented in FIG. 8A may include an additional indication of low confidence for that rapport metric. In example FIG. 8A, the second rapport metric for contact identifier “3” includes an asterisk, which is an example of the type of indication that may be used to designate a low confidence. A designation of low confidence is only one type of indicator that may be provided in connection with the rapport metrics of historical rapport data 802, and other types of indicators may be provided to provide additional contextual information about the historical rapport data 802.

FIG. 8A includes a first, second, and third, weighting values associated with each of the first, second, and third rapport metrics included in historical rapport data 802. In the example FIG. 8A, the first rapport metric is associated with a weighting value of 3, the second rapport metric is associated with a weighting value of 2, and the third rapport metric is associated with a weighting value of 1. While the rapport metrics are depicted in FIG. 8A as each being associated with a unique weighting value, it will be appreciated that the weighting values may be the same for different rapport metrics. Additionally, or alternatively, the weighting values associated with rapport metrics may be different for one contact identifier from another contact identifier. For example, different administrators may configure the systems and methods herein such that different weighting values are assigned to different rapport metrics depending on administrator privileges and preferences.

FIG. 8A includes a rapport score 808. As described herein, a rapport score 808 is intended to provide as an indication of the overall rapport between participants during a contact. Rapport score 808 may be a combination of one or more rapport metrics, such as the first, second, and third rapport metrics depicted in FIG. 8A. In aspects, rapport score 808 may be a weighted combination of one or more rapport metrics. In example FIG. 8A, rapport score 808 may be a weighted combination of rapport metrics RM1, RM2, and RM3 based on the weighting values assigned to each of the rapport metrics and shown in FIG. 8A. It will be appreciated that weighting values assigned to (or otherwise associated with) rapport metrics may be context-dependent, such that weighting values for rapport metrics may vary from one contact to another. For example, weighting values may depend on the type of contact being processed by the rapport engine, such that a weighting value associated with a first rapport metric for a first contact of a first type (e.g., a contact relating to customer complaints) may be different than the weighting value associated with that same, first rapport metric for a second contact of a second type (e.g., a contact relating to a sales question).

The historical rapport data 802 provided in FIG. 8A may be useful for an administrator, customer, or any other user to better understand the performance of various speakers during contacts. For example, the historical rapport data 802 may allow for a determination about relative strengths and weaknesses of agents participating in contacts, which may be used to award agents and/or identify techniques that may lead to improvement in the agent's rapport during contacts. In FIG. 8A, for example, an administrator may access historical rapport data 802 and discern that speaker identifier “1204” has a first rapport metric of 90 or higher across all of the speaker's contacts in the historical rapport data 802. The administrator may use this information to reward the agent associated with speaker identifier “1204” and/or use that agent to train other agents with lower performance in the first rapport metric RM1, such as the agent associated with speaker identifier “1202” whose first rapport metric of 30 is well below the comparable metric of his or her peers.

In a similar fashion, an administrator may use historical rapport data 802 to determine how various rapport metrics relate to customer satisfaction with a given contact. In aspects, FIG. 8A includes customer feedback data 810, which may be data received from a customer or other participant in a contact. Customer feedback data 810 may, for example, be a subjective assessment of the quality of service provided by an agent during a contact and may be a numerical value from 1 to 10. Although shown as a single numerical value, it will be appreciated that customer feedback data 810 may include more than one data field, only some of which or none of which may be numerical values.

In FIG. 8A, an administrator may use customer feedback data 810 to review contacts and identify possible reasons for good—or, conversely, bad—customer feedback. For example, contact identifier “6” includes a customer feedback value of 4, which is the lowest in the historical rapport data. Looking to the historical rapport data 802, one may see that the second and third rapport metrics for contact identifier “6” are relatively high, while the first rapport metric is relatively low. From this historical rapport data 802, one may conclude that the first rapport metric RM1 is more important to customer satisfaction than the second or third rapport metrics. This assessment may be further confirmed by the data associated with contact identifier “5” which shows a moderate customer feedback value of 7 despite low second and third rapport metrics.

It will be appreciated that there are many assessments that one might make based on a review of historical rapport data 802 depending on the particular needs and interests of the reviewer, as well as the type of data included in historical rapport data 802.

For instance, FIG. 8B illustrates an alternative example of the type of historical rapport data 802 that may be determined, stored, and/or provided to a user. In FIG. 8B, historical rapport data 802 is compiled for each speaker identifier 806. In each row, historical rapport scores are provided for the past five contacts in which each speaker was a participant. From this historical rapport data 802, an administrator or other user may be able to determine useful information about agents based on their speaker identifier 806. This information may include insights about the agents' performance over time across a number of recent contacts. In addition, FIG. 8B includes, along with each speaker identifier, a team identifier 807 (or “Team ID”). This Team ID information may identify a team, department, or other type of group to which a speaker belongs. For instance, speakers identified by speaker IDs “1201,” “1202,” and “1202” all belong to a group identified by Team ID “1,” while speakers “1240” and “1255” belong to a group identified by Team ID “2.”

The historical rapport data 802 may further include indicators designed to identify data points of interest to a user. For example, the third rapport score for speaker identifier “1203” includes an example indicator meant to draw a user's attention to a particular data point. In this example, the visual indicator is shown with the speaker's rapport score of 40, which falls well below the other rapport scores for that speaker's recent contacts. This type of indicator may allow a user to identify a specific contact for which a speaker's rapport score was below the speaker's typical performance, such that an administrator may follow up with the speaker to assess whether anything occurred during that contact that warrants further investigation or follow-up.

FIG. 8B further includes an RS Average 812 and an RS Trend 814 for the speaker identifiers 806. Data of this type may be determined and presented to a user to allow the user to assess the relative performance of speakers over time. For instance, an administrator reviewing historical rapport data 802 may determine that speaker identifier 1201 is a high performer deserving of award or praise because the speaker's RS Average 812 is significantly higher than his or her peers. As another example, an administrator may determine that it would be appropriate to set up a meeting with speaker 1202 to investigate the speaker's morale because the speaker has a relatively high RS average 812 but an RS Trend 814 that indicates that the speaker's rapport scores have been decreasing more recently compared to past performance.

Although not depicted in FIG. 8B, it will be further appreciated that historical rapport data 802 may further include information about the relative performance of groups of speakers over time. For instance, historical rapport data 802 may be aggregated for multiple speakers to reflect the relative performance of the groups or teams to which those speakers belong. For example, performance indicators may be determined for the group identified by Team ID “1” by averaging, summing, or otherwise combining the historical rapport data for all speakers associated with that Team ID, which may be then used to determine an RS Average, RS Trend, or other similar performance indicator for that group of speakers. This type of aggregate performance data may allow an administrator to review historical rapport data 802 to identify the best- or worst-performing teams and/or to identify areas for improvement at a group level. In a similar manner, speakers' performance metrics may be aggregated across any other grouping category, such as by aggregating the historical rapport data 802 for all contacts belonging to a specific type or category of contact (e.g., by aggregating historical rapport data for all contacts relating to customer complaints).

FIG. 9 illustrates an exemplary method for calibrating rapport score parameters based on customer feedback data. A general order of the operations for the method 900 is shown in FIG. 9. Generally, the method 900 begins with start operation 902 and end with end operation 920. The method 900 may include more or fewer steps or may arrange the order of the steps differently than those shown in FIG. 9. The method 900 can be executed as a set of computer-executable instructions executed by a cloud system and encoded or stored on a computer readable medium. Further, the method 900 can be performed by gates or circuits associated with a processor, an ASIC, an FPGA, a SOC or other hardware device. Hereinafter, the method 900 shall be explained with reference to the systems, components, devices, modules, software, data structures, data characteristic representations, signaling diagrams, methods, etc., described herein.

Following start operation 902, the method begins with receive operation 904, which receives customer feedback data (such as customer feedback data 810 of FIG. 8A). As described above, customer feedback data may be received from customers and may indicate the customer's satisfaction with a given contact. This feedback data may be subjective or objective and may consist of one or more numerical values, such as a subjective customer satisfaction value between 1 and 10 or other suitable range.

Access operation 906 accesses historical rapport data (such as historical rapport data 802 of FIG. 8A or 8B). Historical rapport data may include historical rapport data from past contacts. For instance, historical rapport data may include one or more rapport metrics, normalized rapport metrics, and rapport scores from past contacts that have been processed according to the systems and methods described herein.

Compare operation 908 compares historical rapport data to customer feedback data. Compare operation 908 may include a numerical or statistical comparison of, for example, rapport scores from past contacts to any customer feedback data received associated with those contacts. For instance, for a given contact, compare operation 908 may compare the rapport score of that contact to a customer feedback score received from the customer who participated in that contact. Compare operation 908 may determine to extent to which the customer feedback data “matches” the rapport score—that is, operation 908 may determine if a contact having a relatively high rapport score also has a relatively high customer feedback score. If contacts are identified for which the rapport score does not align with the customer feedback data (e.g., a contact for which the rapport score was high but the customer feedback data indicated poor customer satisfaction), compare operation 908 may flag those contacts for further analysis and evaluation.

Adjust operation 910 adjusts rapport score parameters based on the comparison of historical rapport data to customer feedback data. Rapport score parameters may include target rapport metrics, rapport metric weights, rapport metric normalization functions, or any other values and/or processes used to generate a rapport score for a given set of contact data. For example, in the event that compare operation 908 identifies and “flags” contacts for which the rapport score and customer feedback data are not aligned, adjust operation 910 may determine whether and how rapport score parameters may be adjusted to result in better alignment of rapport scores and customer feedback data.

As an example, adjust operation 910 may identify that rapport scores are consistently higher than customer feedback scores when a specific rapport metric is low, despite other rapport metrics being high. In that event, adjust operation 910 may determine that the rapport metric weight assigned to the low rapport metric is too low, leading to rapport scores that underweight that rapport metric when determining a rapport score for the contact. Adjust operation 910 may determine that rapport scores would align more closely with customer feedback data if the weighting value assigned to that rapport metric were increased, such that the rapport metric would have a larger effect on the rapport scores determined for contacts.

In another example, adjust operation 910 may determine that adjusting a target rapport metric for a specific rapport metric would result in better alignment of rapport scores and customer feedback. For instance, a target rapport metric of 0.50 for a relative speaking time rapport metric may be initially programmed as the “ideal” value for that rapport metric and, thus, treated as the target rapport metric when, in reality, customer feedback data indicates that customers rate more highly the contacts in which agents contribute closer to 30% of the content of a contact. Thus, adjust operation 910 may adjust the target rapport metric for the relative speaking time rapport metric so that rapport scores will reflect that customer preference.

Recalculate operation 912 recalculates historical rapport data based on any adjustments made at adjust operation 910. For example, if adjust operation 910 determines that a rapport metric should be given a higher weighting value or that a target rapport metric should be adjusted based on revealed customer preferences, recalculate operation 912 may retroactively apply any adjustments to those rapport score parameters such that any historical rapport data from past contacts reflects rapport metrics and rapport scores that would be produced with the adjustments to the rapport score parameters. In this way, historical rapport data is continually evolving to reflect the most accurate and up-to-date understanding of customer preferences, which allows administrators or other users to continually assess the performance of agents or other contact participants using the historical rapport data.

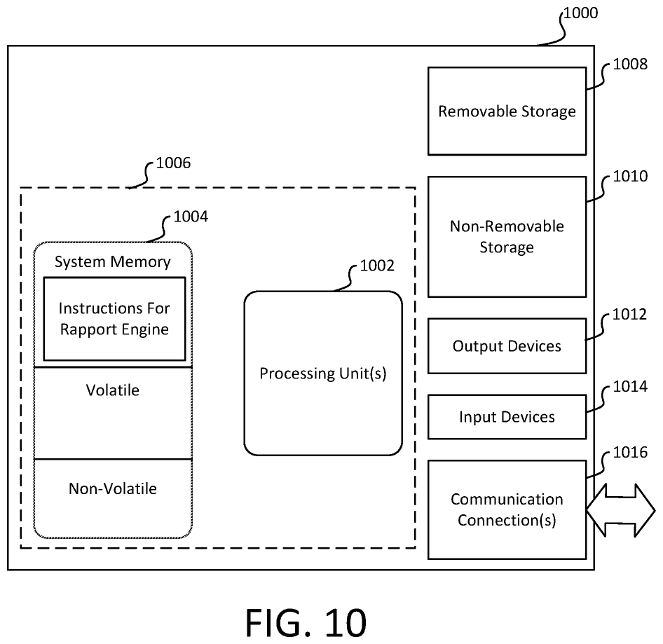

FIG. 10 illustrates a simplified block diagram of a device with which aspects of the present disclosure may be practiced in accordance with aspects of the present disclosure. The device may be a mobile computing device, for example. One or more of the present embodiments may be implemented in an operating environment 1000. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 1000 typically includes at least one processing unit 1002 and memory 1004. Depending on the exact configuration and type of computing device, memory 1004 (instructions to perform a cellular-communication-assisted PPV as described herein) may be volatile (such as RAM), non-volatile (such as ROM, flash memory, etc.), or some combination of the two. This most basic configuration is illustrated in FIG. 10 by dashed line 1006. Further, the operating environment 1000 may also include storage devices (removable, 1008, and/or non-removable, 1010) including, but not limited to, magnetic or optical disks or tape. Similarly, the operating environment 1000 may also have input device(s) 1014 such as remote controller, keyboard, mouse, pen, voice input, on-board sensors, etc. and/or output device(s) 1012 such as a display, speakers, printer, motors, etc. Also included in the environment may be one or more communication connections 1016, such as LAN, WAN, a near-field communications network, a cellular broadband network, point to point, etc.

Operating environment 1000 typically includes at least some form of computer readable media. Computer readable media can be any available media that can be accessed by processing unit 1002 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 1000 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The description and illustration of one or more aspects provided in this application are not intended to limit or restrict the scope of the disclosure as claimed in any way. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Any of the one or more above aspects in combination with any other of the one or more aspect. Any of the one or more aspects as described herein.

What is claimed is:

1. A computer-implemented method for determining a rapport score for a contact, the method comprising:
receiving contact data associated with a contact;
determining a rapport metric from the contact by applying a rapport model to the contact data;
determining a rapport score based on the rapport metric; and
providing the rapport score.

2. The method of claim 1, further comprising selecting a rapport model from a plurality of rapport models.

3. The method of claim 1, wherein the method further comprises:
retrieving a target rapport metric associated with the rapport metric; and
comparing the rapport metric to the target rapport metric to determine a rapport metric deviation, wherein the rapport score is based on the rapport metric deviation.

4. The method of claim 3, wherein the rapport score is inversely correlated with the rapport metric deviation.

5. The method of claim 3, further comprising:
retrieving a plurality of historical rapport metrics associated with a plurality of past contacts and associated with a plurality of historical rapport metric deviations;
comparing the rapport metric deviation to one or more of the plurality of historical rapport metric deviations; and
based on comparing the rapport metric deviation to one or more of the plurality of historical rapport metric deviations, determining a normalized rapport metric for the rapport metric.

6. The method of claim 5, wherein the normalized rapport metric indicates the rapport metric deviation relative to one or more of the plurality of historical rapport metric deviations.

7. The method of claim 2, wherein providing the rapport score comprises storing the rapport score in a rapport score database.

8. The method of claim 7, wherein the rapport score database further comprises an average rapport score associated with the agent and a rapport score trend associated with the agent.

9. The method of claim 1, wherein:
the rapport metric is a first rapport metric; and
wherein the method further comprises determining a second rapport metric.

10. The method of claim 9, wherein determining the rapport score comprises:
retrieving a first rapport metric weight associated with the first rapport metric;
retrieving a second rapport metric weight associated with the second rapport metric; and
wherein the rapport score comprises a weighted combination of the first rapport metric and the second rapport metric based on the first rapport metric weight and the second rapport metric weight.

11. The method of claim 9, wherein the first rapport metric and the second rapport metric comprise at least one of:
a speech ratio metric, the speech ratio metric representing the relative speaking time of the agent compared to the speaking time of the customer during the contact;
a speech speed metric, the speech speed metric representing the speaking speed of the agent during the contact;
an interruption frequency metric, the interruption frequency metric representing the number of times the agent interrupts the customer during the contact;
a name-use frequency metric, the name-use frequency metric representing the frequency at which the agent uses a name of the customer relative to a number of agent utterances;
an emotional model metric, wherein the emotional model metric is based on an emotional state of the customer during the contact;
a mirroring metric, the mirroring metric based on a similarity between an agent statement and a customer statement during the contact;
a relationship-building metric, the relationship-building metric based on using topic modeling to determine a portion of a contact in which the agent attempts to understand a customer need;
an answered question metric, the open question metric based on a count of questions asked by the customer during the contact relative to a count of questions answered by the agent during the contact; or
a question type metric, the question type metric based on a classification of open and closed questions asked by the customer during the contact; and
wherein the first rapport metric and the second rapport metric are different.

12. The method of claim 10, the method further comprising:
receiving customer feedback data associated with the contact;
comparing the rapport score to the customer feedback data;
based on comparing the rapport score data to the customer feedback data, calibrating one or more rapport score parameters.

13. The method of claim 12, wherein the one or more rapport score parameter comprise at least one of:
a first rapport metric weight associated with the first rapport metric;
a second rapport metric weight associated with the second rapport metric;
a first target rapport metric associated with the first rapport metric; or
a second target rapport metric associated with the second rapport metric.

14. A system, comprising:
a processor; and
a memory storing computer-executable instructions that when executed by the processor cause the system to:
receive contact data associated with a contact;
select a rapport model from a plurality of rapport models;
determine a rapport metric from the contact by applying the rapport model to the contact data;
retrieve a target rapport metric associated with the rapport metric;
compare the rapport metric to the target rapport metric to determine a rapport metric deviation, wherein the rapport metric deviation indicates an amount of deviation of the rapport metric from the target rapport metric;
determine a rapport score based on the rapport metric deviation; and
provide the rapport score.

15. The system of claim 14, wherein the instructions, when executed by the processor, further cause the system to:
retrieve a plurality of historical rapport metrics associated with a plurality of past contacts and associated with a plurality of historical rapport metric deviations;
compare the rapport metric deviation to one or more of the plurality of historical rapport metric deviations;
based on comparing the rapport metric deviation to one or more of the plurality of historical rapport metric deviations, determine a normalized rapport metric for the rapport metric; and
wherein determining the rapport score is further based on the normalized rapport metric.

16. The system of claim 14, wherein the instructions, when executed by the processor, further cause the system to:
determine a normalized rapport metric by applying a normalization function to the rapport metric deviation, wherein the normalization function is associated with the rapport metric; and
wherein determining the rapport score is further based on the normalized rapport metric.

17. The system of claim 14, wherein the instructions, when executed by the processor, further cause the system to:
receive customer feedback data associated with the contact;
compare the rapport score to the customer feedback data;
based on comparing the rapport score data to the customer feedback data, calibrate the target rapport metric.

18. A computer storage medium encoding computer executable instructions that, when executed by at least one processor, perform a method comprising:
receiving contact data associated with a contact;
selecting a first rapport model from a plurality of rapport models;
selecting a second rapport model from a plurality of rapport models;
determining a first rapport metric from the contact by applying the first rapport model to the contact data;
determining a second rapport metric from the contact by applying the second rapport model to the contact data;
determining a rapport score based on the first rapport metric and the second rapport metric; and
providing the rapport score.

19. The computer storage medium of claim 18, wherein the method further comprises:
retrieving a first target rapport metric associated with the first rapport metric;
retrieving a second target rapport metric associated with the second rapport metric;
comparing the first rapport metric to the first target rapport metric;
comparing the second rapport metric to the second target rapport metric;
determining a first normalized rapport metric for the first rapport metric based on comparing the first rapport metric to the first target rapport metric;
determining a second normalized rapport metric for the second rapport metric based on comparing the second rapport metric to the second target rapport metric; and
wherein determining the rapport score is based on the first normalized rapport metric and the second normalized rapport metric.

20. The computer storage medium of claim 19, wherein determining the rapport score comprises averaging the first normalized rapport metric and the second normalized rapport metric.
